(19) United States
(12) Patent Application Publication
(10) Pub. No.: US 2006/0274760 A1
(43) Pub. Date: Dec. 7, 2006

(54) Internet packet quality monitor

(75) Inventor: Darren P. Loher, Arvada, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Level 3 Communications, Inc., Broomfield, CO (US)

(21) Appl. No.: 11/146,752

(22) Filed: Jun. 7, 2005

(51) Int. Cl. H04L 12/56

(52) U.S. Cl. 370/395.52; 370/250

(57) ABSTRACT

A system for determining packet quality on an Internet protocol-based (IP-based) network includes a packet test device that traces multiple paths on the IP-based network to obtain node identifiers corresponding to nodes on each path, and an Internet quality monitor (IQM) that associates a quality metric with each path, and associates an identified link between nodes in a path with one of the quality metrics. A method for monitoring quality of data on an Internet protocol (IP)-based network includes deriving a network topology corresponding to a portion of the IP-based network, determining a quality metric associated with a path in the network topology, deriving a link in the path, and determining a quality metric associated with the link based on the quality metric associated with the path.

### BACKGROUND

Internet protocol (IP) telephony, and more specifically Voice over IP (VoIP), are technologies that transmit voice and/or sound data over a data network. VoIP packetizes an analog audio signal and transmits the packets over a network using a network transmission protocol, such as UDP/IP. As such, all the benefits of the Internet can be realized with respect to voice communication. One benefit of VoIP is the sharing of a single network infrastructure by both voice and data. Consumers of VoIP typically benefit due to significant cost savings associated with long distance via VoIP as opposed to costs associated with a traditional telephone network. In addition, VoIP can enable convenient integration of voice conversation with useful computer applications, such as email, instant messaging, video conferencing and so on.

Often, VOIP service providers will provide VoIP service to subscribers over one or more networks that are not owned or operated by the VoIP service provider. Indeed, some VoIP calls might propagate through multiple networks during a call session. In these cases, the operator of the network is transparent to the service being supplied between the service provider and the subscriber. Most Internet based services work this way today. For example, e-commerce is normally conducted over the Internet between businesses without any knowledge or direct interaction with the underlying Internet network operators. While this arrangement is beneficial for network operators and subscribers, it is difficult for the VOIP service providers to identify where call quality problems arise because the VOIP service provider may not own or operate the network, and therefore have very limited visibility to the networks that they are operating over.

VOIP has network performance requirements that are difficult or expensive to measure and monitor and in many cases impossible to guarantee. VoIP performance requirements include packet loss, propagation delay, handling delay and jitter. When one or more of these quality issues exist, the quality of a voice conversation can be noticeably reduced. In order to fix a quality problem, it is necessary to first identify and locate the source of the problem. When considering a small network, such as a Local Area Network, locating a source of a reduced quality may be relatively uncomplicated. However, attempting to identify a source of reduced quality on the Internet as a whole is a much greater challenge.

The Internet is a multi-provider network, in which each provider may have its own systems, such as coding/decoding (CODEC) systems, transmission systems, and so on, for facilitating communication among widely distributed network entities. In addition, the Internet is composed of many subnetworks, which may each exhibit unique characteristics, such as packet loss, delay, jitter, and so on. Each of these systems, networks and network entities may present sources of reduced quality. Consequently, determining the sources of reduced quality over the Internet can be very difficult.

Traditional approaches to identifying sources of reduced quality on the Internet only provide limited and very indirect information to locate problems. In addition, this information does not typically have the accuracy required to detect problems that affect VoIP traffic flows. Other proposed solutions which do supply sufficient test accuracy require the purchase of purpose built test equipment such as active network monitoring probes. Even then, these probes at best only approximate the service quality experienced by users of VoIP systems because they do not directly measure the same network paths and experience that actual consumers of the VoIP service use. Worse, these test probe systems can be very costly.

Thus, a need exists for a system for monitoring quality of data communication that is both cost effective and comprehensive.

### SUMMARY

Embodiments of systems and methods provide for monitoring packet quality over an Internet protocol-based (IP-based) network by identifying a set of nodes and deriving the existence of the links between these nodes. The combination of these nodes and links logically make up network paths. Quality measurements performed across the network path can then be attributed to links, nodes, routes, networks, and other components of a communication network.

A particular embodiment of a system includes a packet test device that traces multiple paths on the IP-based network to obtain node identifiers corresponding to nodes on each path, and an Internet quality monitor (IQM) that associates a quality metric with each path, and associates identified links in a path with one of the quality metrics. The packet test device can employ a Session Invitation Protocol (SIP)—based traceroute function or other IP-based traceroute function for tracing the paths. In some embodiments, the IQM can further attribute the quality metric with an identified Autonomous System (AS) and/or an identified Internet Service Provider (ISP).

A particular embodiment of a method includes deriving a network topology corresponding to a portion of the IP-based network using a number of traceroute functions which identify nodes and paths in the network topology. Then measuring quality metrics for these many paths in the network topology. Further deriving the links which exist in the network from the identified nodes and determining a quality metric associated with the derived links based on the quality metrics associated with the measured paths.

A particular embodiment of a computer-program product includes computer-executable instruction, which, when executed, cause a computer to perform a process for determining quality of data communicated on an Internet protocol-based (IP-based) network. The process includes determining a quality metric associated with each of one or more destination nodes in the IP-based network, tracing a path associated with each destination node using a Session Initiation Protocol (SIP)—based traceroute function or other IP-based traceroute function to determine node identifiers (IDs) corresponding to nodes on each path, and associating a quality metric with each path.

A more complete understanding of the present invention may be derived by referring to the detailed description of preferred embodiments and claims when considered in connection with the figures.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary suitable operating environment for embodiments of Internet packet quality monitors and packet test devices;

FIG. 2 illustrates an exemplary logical topology within which embodiments of the Internet packet quality monitor and the packet test device can conduct packet quality tests and monitor quality associated with nodes in the topology;

FIG. 3 illustrates exemplary data structures that can be generated by embodiments of the Internet packet quality monitor and/or the packet test device;

FIG. 4 illustrates an exemplary algorithm that can be executed by embodiments of the Internet packet quality monitor and/or the packet test device to determine quality of packet communication in an IP-based network;

FIG. 5 illustrates an exemplary SIP-based traceroute algorithm that can be used with embodiments of the Internet packet quality monitor and/or the packet test device; and

FIG. 6 illustrates an exemplary computing device upon which an Internet packet quality monitor can be implemented and executed.

### DETAILED DESCRIPTION

Described herein are various embodiments of systems and methods for monitoring quality of packet communication over an IP-based network. An IP-based network is any communication network in which an Internet Protocol (IP) is used to communicate data (e.g., a TCP/IP based network). As used herein, quality refers to the degree of excellence related to communication of data packets transmitted via a network, which is measurable by one or more characteristics. Examples of measurable characteristics include jitter, packet loss, and latency.

In accordance with various embodiments described herein, packet quality is assessed for one or more paths in the IP-based network. Assessing packet quality generally involves gathering one or more quality metrics for one or more nodes along a path. Multiple nodes are tested and corresponding paths and quality metrics gathered. Based on the multiple paths, a topology of at least a portion of the IP-based network is determined. Using one or more data resources, identified nodes are correlated with node categories, including links, autonomous systems (AS's), Internet service providers (ISPs), and/or geographic locations. The quality metrics then can be associated with the link, AS's, ISPs, and/or geographical location.

Although embodiments described herein are directed toward IP-based voice communication, it will be understood by those skilled in the art that the methods and systems can easily be adapted to any IP-based data that is communicated using an Internet Protocol (IP). For example, systems and methods described herein may be used to determine packet quality of web page data, video data, or any other content that is communicated between nodes on an IP-based network.

As used herein, a node is any uniquely addressable communication device through which IP data travels in the IP-based network. By way of example, and not limitation, gateways, routers, controllers, terminals, servers, computers, network appliances, handheld computers, personal digital assistants (PDAs), and IP-enabled phones are all types of nodes. Typically, as is the case with the Internet, each node is addressable with a unique IP address and/or sub-address. Even when some of the IP addresses in a path are not unique, paths can still be derived which contain information useful to discerning path quality. A link is two or more communicatively coupled nodes. A route refers to the address of one or more nodes. A path is a set of links and nodes which are interconnected in a manner through which data may pass. Thus, a path can include intermediate nodes or links traversed by a packet on the way to a destination node.

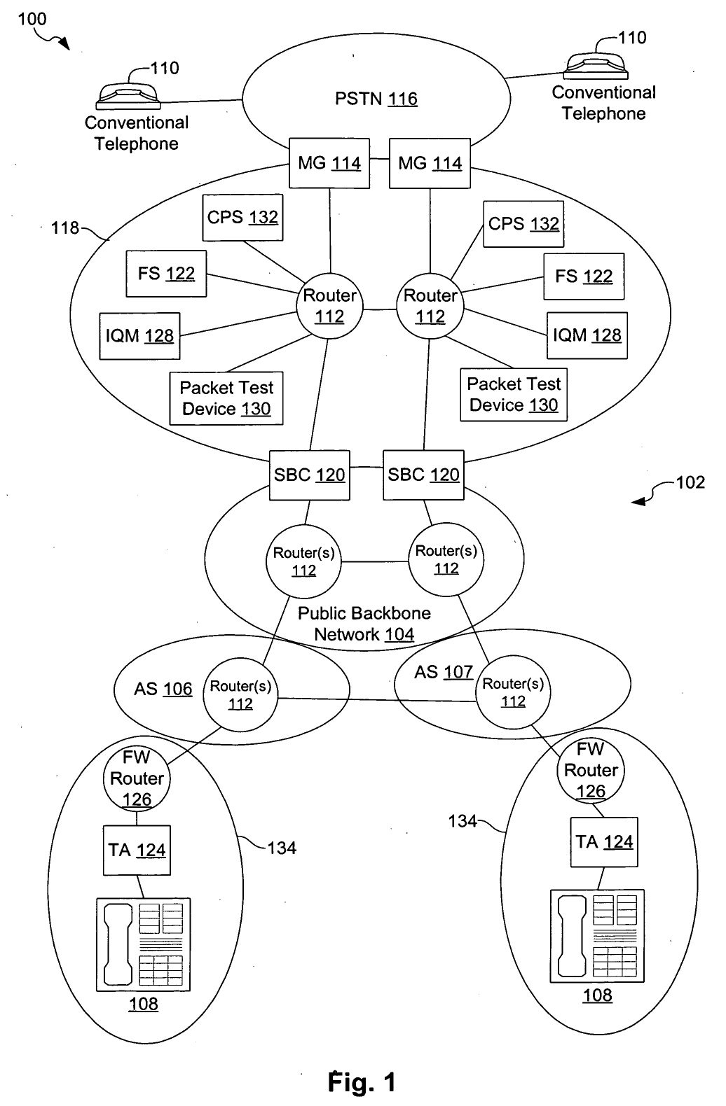

FIG. 1 illustrates an exemplary operating environment 100 in which IP data can be monitored for quality in accordance with an embodiment of the present invention. In this particular embodiment, IP data is any data that is communicated over a network using an Internet Protocol. The operating environment 100 includes a number of networks via which IP data is communicated. An IP-based network, such as the Internet 102, includes one or more public backbone networks 104, one or more autonomous systems (AS's) 106 or 107, one or more private voice networks 118, and on or more individual home or office networks 134.

The AS's 106, 107 can be other provider networks, which can include ISPs. In some embodiments, the AS's 106, 107 provide Internet service to one or more IP-enabled telephonic devices, such as telephones 108. Via the AS's 106, 107 and routers 112, subscriber telephones 108 can communicate with each other using voice over IP (VoIP) either directly or via other public networks 104 and/or private voice networks 118.

In addition, the IP-enabled telephones 108 can communicate with conventional telephones 110. IP data from the IP-enabled telephones 108 is routed via routers 112 through one or more media gateways 114, which convert voice data from the IP-based protocol to a PSTN protocol (e.g., RTP encapsulated audio to Pulse Coded Modulation (PCM) audio), so that the voice data can be transmitted over the public switched telephone network (PSTN) 116. Media gateways 114 also receive data from the PSTN 116 and handle conversion from the PSTN protocol to the IP-based protocol for transmission on the private voice network 118 and other networks, such as public backbones 104, AS's 106, 107, and so on.

In one embodiment, IP voice data is routed through the AS's 106, 107 from and to the public backbone network 104. In addition, public backbone network 104 routes IP voice data to the private voice network 118 via one or more session border controllers (SBCs) 120. An SBC 120 is an optional network security device providing connectivity between public and private networks, and is hereafter referred to as a firewall. The private voice network 118 is a private backbone network that provides voice call routing and feature support. In accordance with this aspect of the invention, private voice network 118 includes one or more feature servers (FS's) 122 and one or more SIP proxy servers (SPS) 132. FS 122 provides various voice services, such as, but not limited to, caller identification, call forwarding, and voice mail. The SPS 132 is not limited to private voice networks, but can be employed in numerous types of data networks. In addition, SPS 132 provides call routing support for calls passing through the private voice network 118.

Referring more specifically to AS's 106, 107, each AS 106 or 107 is a collection of administratively associated nodes that are connected by links to form a network. At least a portion of these nodes and links are typically administrated by an identifiable entity, such as an Internet service provider. In addition, it is likely that many other nodes within a given AS are administered by another entity other than the one associated with the AS number. In these cases, information is sometimes available to associate an administrative organization based on the route or IP address which will more precisely identify the operator of a node. As illustrated in FIG. 1, each AS 106, 107 can interconnect and communicate with one or more other AS's. Typically, the external border gateway protocol (EBGP) is employed to facilitate communication between AS's. In addition, one or more AS's 106, 107 may be located in one or more geographic regions (e.g., cities) to provide service to subscribers in those regions. When voice data is communicated from one region to another region, or even within the same region, the voice data may be routed onto one or more different networks that may or may not be controlled by the same AS 106, 107.

IP-enabled telephones 108 communicate over the Internet 102 to nodes on the network. This can involve the use of terminal adapters (TA) 124 and/or routers 126. TA's 124 perform data conversion and signaling to control voice communication sessions. The TA's 124 can be built into the telephones 108 or the TA's 124 can be separate units. Often, the VoIP service providers sell or otherwise furnish the TA's 124 to the subscribers. Further, TA's 124 can be purchased at computing equipment stores, or the like. In the embodiment shown in FIG. 1, the TA's 124 communicate IP voice data to the Internet (e.g., AS 106) via a router 126. In the illustrated embodiment, router 126 is a firewall router which can perform network address translation (NAT) and other security functions, such as encryption, decryption, virus protection, etc.

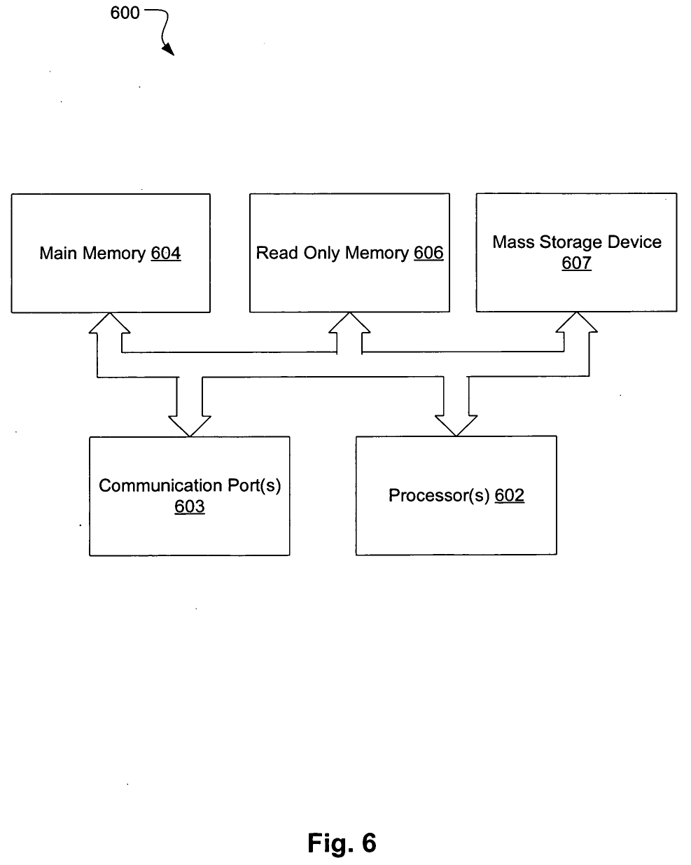

Referring again to the private voice network 118, included therein are one or more Internet quality monitors (IQM) 128, and one or more packet test devices 130. It is to be understood that the location of the packet test devices 130 and the IQMs 128 within the Internet 102 is not limited to the private voice network 118. For example, in other embodiments, multiple packet test devices 130 and IQMs 128 may be advantageously positioned at numerous locations in the IP-based network in order to obtain quality and network information from useful vantage points. The IQMs 128 and the packet test devices 130 can be implemented in a number of ways, including, but not limited to, general purpose computers, database servers, or special purpose computers. In addition, one of the preferred implementations of the packet test device is to integrate it into the media gateway, a firewall, a terminal adapter, a VOIP telephone, or other device or system. An exemplary computing device is illustrated in FIG. 6 and discussed below.

In one embodiment, the IQM 128 controls the packet test device 130 to gather data regarding packet quality and network topology. The IQM 128 analyzes the gathered data to calculate quality metrics corresponding to network paths and generates data representing the network topology. The network topology is analyzed to identify relevant geographic locations, ISPs, autonomous systems 106, 107, and/or links. Quality metrics can be attributed to the identified geographic locations, ISPs, systems, or links using various correlation operations carried out by the IQM 128.

In one embodiment, the IQM 128 can perform active or passive tests to gather quality metrics and node identity information. An active test involves causing the packet test device 130 to transmit known packets to a destination node and having the packets looped back to the packet test device 130. In this and other embodiments, TA's 124 or other nodes in the network send back test signal packets when received. The TA's 124 and/or other nodes can include intelligence to determine when a received signal is a test signal that should be looped back.

Upon receiving the looped back test signals, The IQM 128 then measures characteristics of the packets, such as latency, jitter, and packet loss to determine quality metrics. The active test also involves determining the path traveled by the packets over the Internet 102 to reach the destination node. A “traceroute” function can be performed to identify a path or route. The path includes nodes (i.e., routers, gateways, etc.) through which the packets travel to reach the destination node. In an active test, the nodes between the packet test device and the destination node are referred to as intermediate nodes.

During a passive test, the IQM 128 receives reports from TA's 124 and MG's 114 which passively monitor actual user data flows that are in progress. In these passive tests, the TA 124 and MG 114 may or may not know what the data flow should look like. Many VoIP codecs send at fixed data and packet rates. In this case where the data being transmitted is a known quantity, the IQM can derive at least the packet loss and jitter based on the rate and interval at which packets are received. The preferred implementation of the quality monitoring system contains instances of the IQM 128 function on the end points of data flows. For example, an instance of IQM can be embedded in MGs 114 and TAs 124.

Due to the unidirectional nature of this measurement technique, measurements can be made for data flows which are one-way, two-way and “n-way”. In addition, when there is more than one flow, there is a high probability on the Internet that these flows will not actually take the same path, even in a simple two-way data flow. These asymmetric data flows are automatically handled due to the unidirectional measurement technique.

In other cases, the data endpoints (TA's and MG's) can report their performance to one another across the network. In this method, endpoints can know each other's observed performance. This method can enable one-way latency measurements when timestamp information is exchanged. This method can be additive to or in place of the derived performance method described above. In addition, a performance reporting method is required between the MG 114 or TA 124 data endpoints in the case that data is not being sent in a format which is not-deterministic to the receiver. An example of an implementation of this method is the RTCP protocol (add reference to http://www.ietf.org/rfc/rfc1889.txt).

The IQM 128 relies upon the TA's 124, MG's 114 and/or other nodes on the network for information regarding quality. TA's 124 can send quality information such as jitter, latency, packet loss, path information and other information such as location based on coordinates, postal code address, the user and operator of the device, etc.

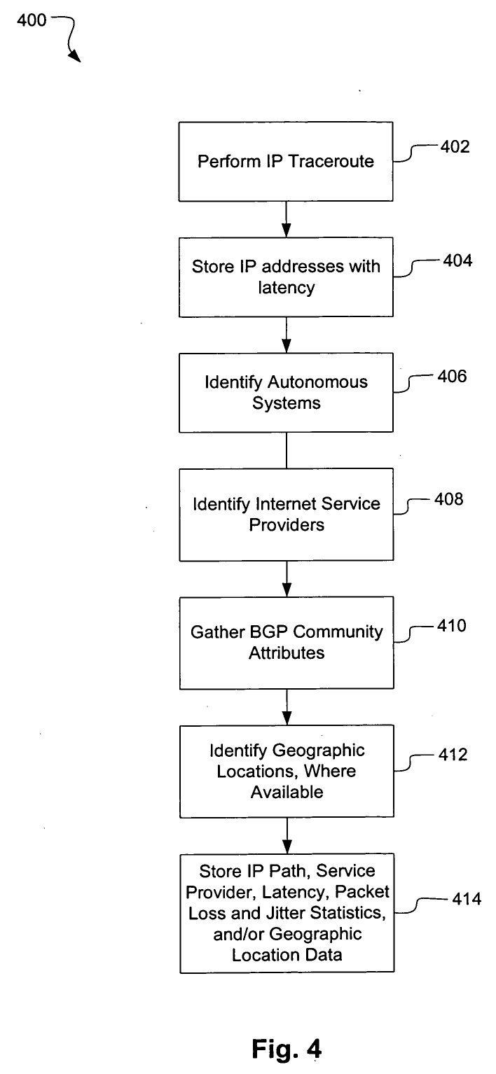

During a passive test there is at least one source node and a destination node. Multiple sources and destinations are also possible. Nodes between the source nodes and the destination nodes are intermediate nodes. A source or destination of one flow could be an intermediate node to other flows. An exemplary embodiment of the packet quality test is described in more detail below with reference to FIG. 4.

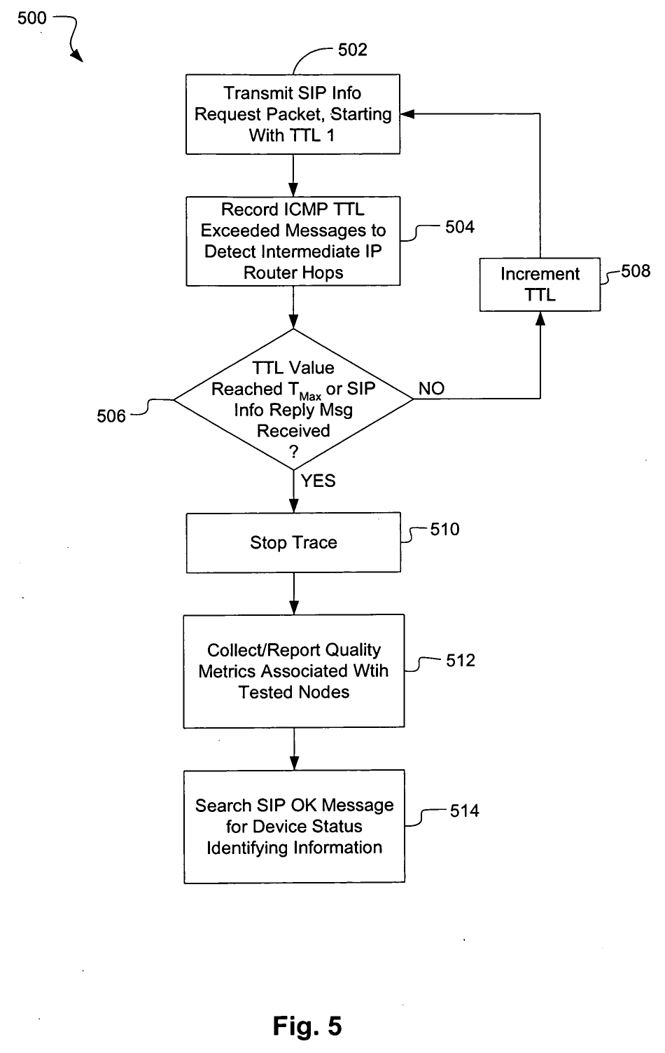

With regard to identifying nodes on paths during testing, in some embodiments, Packet Test Device's 130, MG's 114 and TA's 124 can perform a traceroute function. The traceroute information may be obtained using session invitation protocol (SIP) (i.e., SIP-based route tracing) or IP based tracerouting. Embodiments using SIP—based route tracing can be operable to traverse home firewalls 126 by keeping a pinhole open for sending SIP requests to another accessing communication device, such as a computer or VoIP phone 108. This may be used to reduce or eliminate the possibility of a home firewall 126 blocking SIP requests related to establishing a call to the communication device 108. One embodiment of the SIP-based tracing algorithm is discussed in more detail with regard to FIG. 5.

Typically, the IQM 128 collects test reports from many nodes (e.g., thousands). Thus, a large amount of information is gathered regarding paths in the IP-based network and the identities of nodes on those paths. Using the node identities and routing information, the IQM 128 determines a logical topology associated with the IP-based network. In addition, over time, as more tests are performed, and alternate paths are used to reach previously tested destination nodes, the logical topology information can be refined to more clearly indicate the topology or changes in the logical topology. The IQM 128 can use the information about the logical topology of the network and the path quality metrics to attribute quality metrics to not only nodes in the network, but also links, autonomous systems, ISPs, and geographic locations. As used herein, logical topology refers to the logical arrangement of linked nodes.

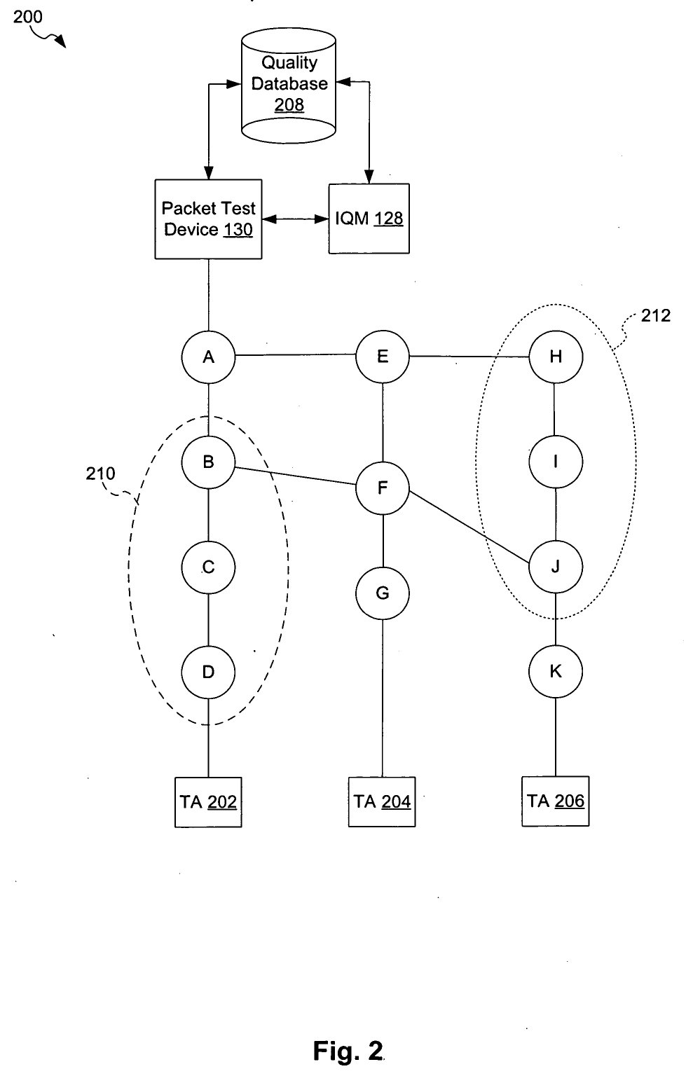

FIG. 2 illustrates an exemplary logical topology 200 corresponding to a portion of an IP-based network (e.g., the Internet). In the illustrated example, four nodes are used to perform active and passive tests in the topology 200. The nodes in this example are terminal adapter 202, terminal adapter 204, terminal adapter 206 and packet test device 130. Data generated during the tests is stored in a quality database 208, from which the data can be retrieved and analyzed by the IQM 128.

Within the exemplary topology 200, intermediate nodes A through K exist on the various paths between the nodes 130 and 202-206. The exemplary logical topology 200 is not intended to limit the scope of topologies upon which quality tests can be performed, but rather to illustrate how quality tests can be carried out in a simplified example. In an actual IP-based network, numerous other logical topologies, and much larger topologies might exist.

As illustrated in the exemplary logical topology 200, nodes B, C, and D are part of a first autonomous system 210, and nodes H, I, and J are part of a second autonomous system 212. Thus, in the illustrated embodiment, when packets are being sent to and from terminal adapter 202, the packets travel through the first autonomous system 210. Similarly, when packets are sent to and from terminal adapter 206, the packets travel through at least a portion of the second autonomous system 212.

In an exemplary active test, packet test device 130 and terminal adapter 202 transmit packets to each other. Because the user of the terminal adapter 202 is a subscriber to the VoIP service provider which is operating the packet test device, the IP address of the TA 202 is known to, and addressable by, the packet test device 130. The TA 202 performs a function (e.g., loop-back function) that loops the data packets back to the packet test device 130. Thus, the packet test device 130 receives the looped back packets.

Using the looped back packets, the IQM 128 can determine various quality metrics related to the nodes in the topology 200. In one embodiment, the IQM 128 determines latency, jitter, and packet loss metrics associated with the packets. Other quality metrics may be gathered or computed. The quality metrics are stored in the quality database 208.

In order to associate the quality metrics with particular nodes and/or paths, the packet test device 130 and the terminal adapter 202 can perform a traceroute function. The traceroute function yields information (e.g., IP addresses) regarding the path taken by packets to reach destination nodes. For example, when performing a traceroute from packet test device 130 to TA 202, the traceroute function provides the IP addresses of intermediate nodes A, B, C, and D. The traceroute function can also provide a rough estimate of latency and packet loss information related to each intermediate node A, B, C, and D and the end node, terminal adapter 202. The same traceroute function is also performed from TA 202 back to packet test device 130. Even though there is one looped back data flow, this is in actuality two logical tests, one from packet test device 130 to TA 202 and a second measurement from TA 202 to Packet Device 130. Identifiers for Packet Test Device 130 and TA 202 are stored in the quality database 208 in association with the corresponding path and quality metrics for each logical test. In the quality database 208, the path includes the intermediate node identifiers.

The packet test device 130 may iterate through numerous IP addresses of subscribing TA's in order to obtain as much information as possible regarding the topology 200. The nodes may be iteratively selected according to an ordered list of nodes. Alternatively, the selection of nodes may be event-driven; for example, when information is received regarding a potential quality problem at a particular node, the node can be selected for testing. Accordingly, in another active test, the packet test device 130 transmits test packets to TA 204 and gathers quality metrics and traceroute information regarding TA 204 and corresponding intermediate nodes. In a similar fashion, quality metrics and intermediate node identifiers are gathered regarding the path to TA 206. The paths, quality metrics and intermediate node identifiers are stored in the quality database 208 in association with identifiers for TA's 204, 206.

In the illustrated exemplary topology 200, packets communicated over the network may take numerous different paths to reach each of the destination nodes. For example, test packets sent from the packet test device 130 to the TA 204 may travel a path including nodes A, E, F, and G. Alternatively, the packets may travel the path including nodes A, B, F, and G. When test packets are sent to TA 206, the packets are likely to travel via one or more of three paths: a first path including nodes A, E, H, I, J, and K; or a second path including nodes A, E, F, J, and K; or a third path including nodes A, B, F, J, and K. Using data gathered from the different paths, quality metrics can be associated with different paths, nodes, links, AS's, and/or other node combinations.

The IQM 128 uses one or more data resources to classify or group nodes in meaningful ways. For example, the IQM 128 can determine that nodes B, C, and D are part of first autonomous system 210 or determine that nodes H, I, and J are part of the second autonomous system 212. In one embodiment, the IQM 128 obtains node IP addresses and other routing data from the Internet BGP routing protocol and uses the “WHOIS” tool from Internet Network Information Center (InterNIC) to identify a host, domain, or ISP associated with the intermediate nodes. In another embodiment, the IQM 128 can use a route registry (RR) to look up which routes belong to which ISPs. In yet another embodiment, the IQM 128 can use information from border gateway protocol (BGP).

In another embodiment, the IQM 128 can perform a passive test. A passive test involves gathering quality data and topology data related to communications between nodes as part of the normal course of operations without involving a packet test device. In this embodiment, the data that is communicated is not known to the IQM 128 a priori; however, quality metrics can be gathered from or reported by the nodes involved in data flows. In a passive test, the IQM 128 relies on the TA nodes to report quality metrics. Thus, for example, after or during a communication session between TA 202 and TA 204, TA 202 and/or TA 204 can report to the Quality Database 208 or IQM 128 with quality metrics. TA 202 and TA 204 can perform traceroute functions to determine the intermediate node topologies associated with TA 202 and TA 204 communication. Active and passive tests can be performed in combination or separately.

After the active and/or passive tests, data reported to the IQM 128 can be used to determine where sources of reduced quality exist in the network topology 200. Differences in quality metrics associated with different paths can indicate sources of quality problems. For example, if the test of TA 204 yields high quality metrics with the path through nodes A, B, F, and G, while the test of TA 202 yields low quality metrics with the path through nodes A, B, C, and D. It is likely that the link between A and B is delivering good quality, but that some link between node B, C, D and TA202 has a quality problem. This problem can also be associated with AS 210. If geography information is available regarding the AS 210 and the TA 202, the source of the low packet quality may be further associated with a particular geographic region.

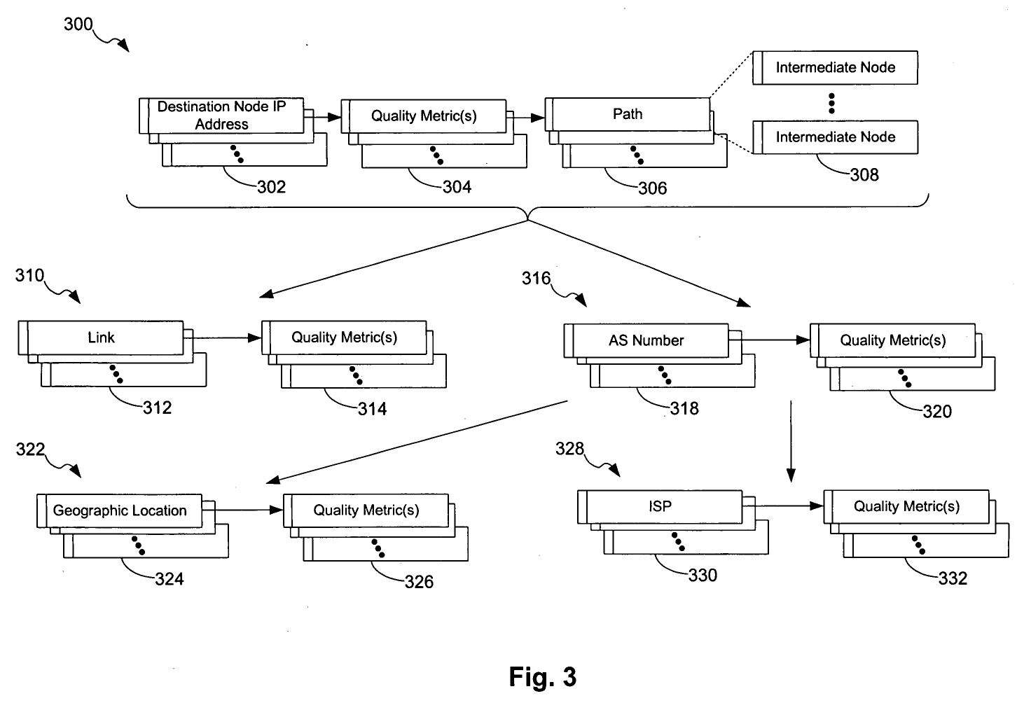

FIG. 3 illustrates exemplary data structures that could be created during monitoring of packet quality over an IP-based network. The data structures can be created in a relational database and accessed using database queries. One skilled in the art will appreciate that other database structures could also be used. Initially, topology information is gathered regarding paths on the IP-based network. The paths can include a starting node, a destination node, and one or more intermediate nodes. Quality metrics measured from tests are gathered and stored as entries in the path table 300.

A particular embodiment of the path table 300 includes a list of destination node identifiers 302, a list of associated quality metrics 304, and a list of associated paths 306. In this embodiment, each path 306 contains a list of one or more identifiers 308 for nodes along the path 306. Using information from the path table 300, other useful data structures can be created.

For example, a link table 310 can be created that includes a list of link 312 with corresponding quality metrics 314. In this embodiment, a link is associated with two adjacent nodes. The quality metrics 314 are obtained from the path table 300 and attributed to the corresponding links using a correlation algorithm. In one embodiment of the correlation algorithm, a plurality of quality metrics are aggregated for nodes, links, or paths, and an exponential smoothing function is performed with respect to the quality metrics. An exemplary link table is shown below as Table 1:

TABLE 1
Exemplary Link Table

| | | | | Packets | Last Time |
|---|---|---|---|---|---|
| Adjacency | Node1 | Node2 | Latency | Sent | Measured |
| Adjacency | IP1 | IP2 | 5 ms | 9000 | 10/4/04, |
| 1_Test_4 | | | | | 12:00 |
| Adjacency | IP7 | IP8 | 20 ms | 18000 | 10/4/04, |
| 2_Test_94 | | | | | 12:01 |
| Adjacency | IP8 | IP7 | 20 ms | 18000 | 10/4/04, |
| 3_Test_94 | | | | | 12:02 |

In Table 1, the column labeled “Adjacency” includes a list of identifiers for link. Columns labeled “Node1” and “Node2” provide the associated first and second node identifiers (e.g., IP addresses) for associated nodes. The “Latency” column includes latency values for the associated link. The column labeled “Packets Sent” includes the number of packets sent from node1 to node2 by the testing (passive and active). In this embodiment, test packets are sent between node 1 and node 2. The number of test packets is counted as derived from the tests being performed. Column labeled “Last Time Measured” provides the date and time of the last measurements associated with the links.

Another table that may be created is an autonomous system (AS) table 316. The illustrated embodiment of the autonomous system table 316 includes a list of AS numbers 318 with a corresponding list of quality metrics 320. In this embodiment, an algorithm is employed to associate quality metrics from the path table 302 with the corresponding AS number in the AS table 316. Table 2 shown below is an exemplary AS table:

TABLE 2
Exemplary AS Table

| PTD | AS-x ATL1 | AS-y ATL1 | AS-x SJO1 | AS-y SJO1 | AS-x NYC1 | AS-y NYC1 |
|---|---|---|---|---|---|---|
| PTD1 | L: 30 ms | L: 38 ms | L: 80 ms | L: 86 ms | L: 50 ms | L: 72 ms |
| ATL1 | Loss: 0.01% | Loss: 0.05% | Loss: 0.00% | Loss: 0.00% | Loss: 0.01% | Loss: 0.25% |
| | Jitter: 1 ms | Jitter: 3 ms | Jitter: 1 ms | Jitter: 1 ms | Jitter: 1 ms | Jitter: 12 ms |
| | AS-path: 1, 2, x | AS-path: 1, y | AS-path: 1, x | AS-path: 1, 5, y | AS-path: 1, 5, x | AS-path: 1, 5, y |
| PTD1 | L: 60 ms | L: 65 ms | L: 25 ms | L: 29 ms | L: 70 ms | L: 78 ms |
| SJO1 | Loss: 0.00% | Loss: 0.06% | Loss: 0.00% | Loss: 0.00% | Loss: 0.01% | Loss: 0.29% |
| | Jitter 1 ms | Jitter 3 ms | Jitter 0 ms | Jitter 1 ms | Jitter 1 ms | Jitter 14 ms |
| | AS-path: 1, 2, x | AS-path: 1, y | AS-path: 1, 2, x | AS-path: 1, y | AS-path: 1, 2, x | AS-path: 1, 2, y |
| PTD1 | L: 52 ms | L: 75 ms | L: 70 ms | L: 85 ms | L: 5 ms | L: 11 ms |
| NYC1 | Loss: 0.01% | Loss: 0.04% | Loss: 0.00% | Loss: 0.05% | Loss: 0.06% | Loss: 0.26% |
| | Jitter 1 ms | Jitter 3 ms | Jitter 1 ms | Jitter 2 ms | Jitter 3 ms | Jitter 11 ms |
| | AS-path: 1, x | AS-path: 1, 2, y | AS-path: 1, x | AS-path: 1, 2, y | AS-path: 1, x | AS-path: 1, 2, y |

Table 2 illustrates the results of six tests of two autonomous systems (AS-x, AS-y) in three cities (Atlanta, San Jose, and New York City). The terms ‘x’ and ‘y’ are placeholders for AS numbers or identifiers. The column labeled “PTD” includes a list of Packet Test Device 130 identifiers and the location of the Packet Test Device 130. The other columns identify the test number, the particular AS, the corresponding quality metrics, and a list of AS's that were traversed in the path.

To illustrate, in the first column for AS-x Atlanta represents the quality metrics derived from test paths which traveled from the base network in Atlanta to AS-x , using Atlanta as the egress point from the base network. The quality values derived by creating an exponentially smoothed average of test data show the latency as 30 milliseconds (ms), packet loss was determined to be 0.01%, jitter was determined to be 1 ms, and the path to AS-x when using Atlanta as an egress point includes intermediate AS's 1, and 2. The values 1, and 2 correspond to intermediate AS's which are between the base network and AS-x when Atlanta is used as an egress point.

Referring again to FIG. 3, another table that may be generated is a geographic location table 322 when geographic information is available. The geographic location table 322 includes a list of identifiers of geographic locations 324 and a list of corresponding quality metrics 326. Again, using a correlation algorithm, the quality metrics 326 are obtained from the path table 300 and associated with the geographic locations 324. The geographic locations 324 may be any useful identifiers, such as, but not limited to, city names, street names, or county names. Geographic information can be made available from subscribers to a network service, or other resources for geographic data.

Another table shown in FIG. 3 is an ISP table 328. The ISP table 328 associates quality metrics with ISPs. Accordingly, the exemplary ISP table 328 includes a list of identifiers of ISPs 330 and a list of corresponding quality metrics 332. The associations made between ISPs and quality metrics can be obtained using various resources, such as, Whois, RR, or domain naming server (DNS).

While FIG. 3 illustrates embodiments of various exemplary tables, each having their own information, it will be understood that the tables may be combined in any useful manner. For example, the list of ISPs 330 could be included in the AS table 316, such that each AS 318 is associated with an ISP 330. In addition, as one skilled in the art will appreciate, other table structures and/or database structures can be used. Thus, the disclosed system is not limited to this particular embodiment.

FIG. 4 illustrates a correlating algorithm 400 for correlating quality metrics with identified categories of nodes. Nodes may be categorized in various ways, including, without limitation, geographically, by associated autonomous system, by associated ISP, by network path, or by link. Generally, after quality metrics are derived for multiple individual nodes, various data resources are used to correlate nodes, and their associated quality metrics, with specified categories of nodes.

Initially, the IQM or packet test device performs a traceroute function in tracing operation 402. The results of the traceroute function typically include a list of node identifiers (e.g., IP addresses) and other information, such as latency associated with each node. Packet loss, jitter and latency statistics can also be obtained from various network resources, such as a media gateway. An exemplary method for obtaining these statistics is to derive them from the RTP VoIP media flow of receiving and transmitting nodes.

In a storing operation 404, the IQM stores the IP addresses, latency values and/or other quality metrics generated from the tracing operation 402. In one embodiment, the IP addresses and associated latencies are stored in a relational database. In another embodiment, the IP addresses and associated latencies are stored in a table such that latencies and RTP statistics can be retrieved for selected paths or nodes.

An identifying operation 406 identifies one or more autonomous systems related to nodes found during the tracing operation 402. The identifying operation 406 first determines AS numbers associated with the IP addresses of nodes found in the tracing operation 402. The AS number can be determined by looking up the IP addresses in network databases or other resources. After the AS numbers are determined, an AS path is established. The AS path includes the nodes in the identified AS. The AS numbers and their associated paths are stored in memory.

Another identifying operation 408 identifies Internet service providers (ISPs) associated with the IP addresses and the AS numbers determined in the tracing operation 402 and the identifying operation 404, respectively. One embodiment of the identifying operation 408 can employ the “Whois” function. By performing “Whois” with the IP addresses and/or the AS numbers as arguments, corresponding ISPs can be identified. Other implementations of the identifying operation 408 may use another network-based resource in addition to, or other than, the “Whois” function.

A gathering operation 410 gathers other community attributes associated with IP addresses in the path(s). In one embodiment, the gathering operation 410 performs queries into a routing registry (RR) to obtain information related to the BGP gateway community. Exemplary information that can be obtained in the gathering operation 410 includes routing information about IP address ranges and sometimes geographic information.

Another identifying operation 412 identifies geographical locations associated with identified nodes. The geographical location can be determined by correlating subscriber information with other geographic information related to the identified nodes, autonomous systems, and/or ISPs. For example, when a customer subscribes to the service provider, the customer typically provides his/her residential address (street address, city, state, country) from which the customer will be attaching to the network. As another example, global positioning system (GPS) coordinates associated with the subscriber device or other nodes may be provided by the subscriber, the subscriber device, or other nodes. These coordinates can be supplied via DNS, DHCP or other standard Internet Protocols. A storing operation 414 stores the available, identified AS path(s), ISP(s), packet loss, latency and jitter statistics and geographic location data.

The correlating algorithm 400 is typically performed repeatedly over time to capture changes in network topology and quality metrics and to determine trends in network quality. For example, the time of day may be recorded and associated with tests in order to trend quality metrics based on the time of day. Other relations may be determined in addition to, or other than, those shown and described in FIG. 4.

FIG. 5 illustrates an exemplary Session Invitation Protocol (SIP)—based route tracing algorithm 500 for determining packet quality using SIP—based tracerouting. In this embodiment, the SIP-based algorithm 500 performs a tracing function between SIP endpoint peers in a communication session. Operations in the SIP-based algorithm are typically facilitated by NAT traversal managers and/or proxies which pass and redirect SIP information packets. SIP-based traceroute information is reported to one or more peers and can be used to determine network topology and attribute quality metrics with network nodes. Advantageously, the SIP-based approach can traverse SIP application layer gateways (ALGs) and firewalls to provide a better assessment of the path between SIP—signaled endpoints.

A transmitting operation 502 transmits a SIP information request packet with a specified time-to-live (TTL). The initial TTL value is one. A recording operation 504 records Internet control message protocol (ICMP) TTL exceeded messages during the tracing. The recorded TTL exceeded messages may be used to detect intermediate IP router hops.

A repeating operation 506 repeats the transmitting operation 502 and recording operation 504 until either the TTL value has reached a specified maximum value, Tₘₐₓ, or a SIP information reply message is received from the destination node. Each time the transmitting operation 504 is performed, the TTL value is incremented in incrementing operation 508. In one embodiment, the specified maximum TTL value is 30.

When the maximum TTL value or SIP OK message is received, the trace is stopped in operation 510. A collecting operation 512 then collects quality metric information and node identification information. In one embodiment, the collecting operation 512 reports the collected information to an IQM, which correlates the node identification information as discussed above with respect to the correlating algorithm 400 in FIG. 4. Quality measurements can be derived from the transmitted packets themselves. The pattern in which the packets are received can be used. For example, the rate, timing, volume, etc., of packet receipt can be used to determine communication quality. In an optional searching operation 514, if a SIP OK response was received, the SIP OK response is searched for information related to device status.

FIG. 6 is an example of a computer system 600 with which embodiments of the present invention may be utilized. Computer system 600 represents an exemplary Internet quality monitor or packet test device which may implement one or more of the packet quality monitoring algorithms discussed above (i.e., tracerouting, SIP-based tracing, topology determination, and traceroute data correlation with quality metrics). In this simplified example, the computer system 600 comprises a bus 601 or other communication means for communicating data and control information, and one or more processing devices 602, such as a well known processor, Application Specific Integrated Circuit (ASIC), a field programmable gate array (FPGA), or the like, coupled with bus 601.

In this simplified embodiment, computer system 600 further comprises a random access memory (RAM) or other dynamic storage device (referred to as main memory 604), coupled to bus 601 for storing information and instructions to be executed by processing device 602. Main memory 604 also may be used for storing temporary variables or other intermediate information during execution of instructions by processor(s) 602.

Computer system 600 can also include a read only memory (ROM) 606 and/or other static storage device coupled to bus 601 for storing static information and instructions for processing device 602. A mass storage device 607, such as a magnetic disk or optical disc and its corresponding drive, may also be coupled to bus 601 for storing instructions and information, such as configuration files, a key store and registration database, etc.

One or more communication ports 603 may also be coupled to bus 601 for supporting network connections and communication of information to/from the computer system 600 by way of a communication network, such as a Local Area Network (LAN), Wide Area Network (WAN), or the Internet, for example. The communication ports 603 may include various combinations of well-known interfaces, such as one or more modems to provide network access, one or more 10/100 Ethernet ports, one or more Gigabit Ethernet ports (fiber and/or copper), or other well-known network interfaces commonly used in internetwork environments. In any event, in this manner, the computer system 600 may be coupled to a number of other network devices, communication devices, clients, NTMs, and/or servers via a conventional communication network infrastructure.

Optionally, operator and administrative interfaces (not shown), such as a display, keyboard, and a cursor control device, may also be coupled to bus 601 to support direct operator interaction with computer system 600. Other operator and administrative interfaces can be provided through network connections connected through communication ports 603.

Finally, removable storage media (not shown), such as one or more external or removable hard drives, tapes, floppy disks, magneto-optical discs, compact disk-read-only memories (CD-ROMs), compact disk writable memories (CD-R, CD-RW), digital versatile discs or digital video discs (DVDs) (e.g., DVD-ROMs and DVD+RW), Zip disks, or USB memory devices, e.g., thumb drives or flash cards, may be coupled to bus 601 via corresponding drives, ports or slots.

Various exemplary methods, systems, and devices have been illustrated in the accompanying drawing and described in the foregoing detailed description. It will be understood that the methods and systems shown and described are not limited to the particular embodiments described herein, but rather are capable of numerous rearrangements, modifications, and substitutions without departing from the scope and spirit of the claims set forth below.

What is claimed is:

1. A method for monitoring quality of data transmission on an Internet protocol (IP)-based network, the method comprising:
deriving a network topology corresponding to at least a portion of the IP-based network, wherein the network topology includes one or more paths in the IP-based network;
determining a quality metric associated with each of the one or more paths in the network topology;
deriving one or more links associated with each of the one or more paths, wherein each link includes two or more nodes in an associated path; and
determining a quality metric associated with each of the one or more links based on the quality metrics associated with the one or more paths.

2. A method as recited in claim 1 wherein the IP-based network is a voice over IP (VoIP) network.

3. A method as recited in claim 1 further comprising analyzing traceroute data and quality metrics related to different paths to identify sources of reduced quality.

4. A method as recited in claim 1, wherein deriving the network topology comprises performing a Session Initiation Protocol—based (SIP-based) traceroute function to determine node identifiers (IDs) corresponding to nodes on each of the paths.

5. A method as recited in claim 1, wherein deriving the network topology comprises:
transmitting one or more data packets to a destination node, wherein the data packets traverse one of the paths associated with the destination node; and
gathering node identifiers for intermediate nodes along the associated path.

6. A method as recited in claim 1, wherein determining a quality metric comprises:
receiving looped back data packets; and
measuring one or more of packet loss, jitter, and latency associated with the looped back data packets.

7. A method as recited in claim 1, wherein determining a quality metric comprises receiving the quality metric from a destination node, the quality metric representative of quality of data communicated between the destination node and a source node.

8. A method as recited in claim 1, further comprising:
determining an autonomous system based on the network topology; and
associating one of the quality metrics with the autonomous system.

9. A method as recited in claim 1, further comprising:
determining an Internet Service Provider (ISP) based on the network topology; and
associating one of the quality metrics with the ISP.

10. A computer-program product having computer-executable instructions, which, when executed, cause a computer to perform a process for determining quality of data communicated on an Internet protocol-based (IP-based) network, the process comprising:
determining a quality metric associated with each of one or more destination nodes in the IP-based network;
tracing a path associated with each destination node using a Session Initiation Protocol (SIP)—based traceroute function to determine node identifiers (IDs) corresponding to nodes on each path; and
associating a quality metric with each path.

11. A computer-program product as recited in claim 10, the process further comprising deriving one or more links between nodes associated with each path, wherein each link includes two linked nodes in an associated path.

12. A computer-program product as recited in claim 10, the process comprising:
determining an autonomous system including one or more nodes on one of the paths; and
attributing one of the quality metrics to one or more of the autonomous system, or a path, link, or node associated with the autonomous system.

13. A computer-program product as recited in claim 12, wherein attributing one of the quality metrics comprises:
aggregating a plurality of quality metrics associated with the path, link, node, or autonomous system; and
performing an exponential smoothing operation on the plurality of quality metrics.

14. A computer-program product as recited in claim 10, the process further comprising:
determining an Internet Service Provider (ISP) including one or more nodes on one of the paths; and
attributing one of the quality metrics to the ISP.

15. A computer-program product as recited in claim 11, the process further comprising attributing one of the quality metrics to at least one of the links.

16. A computer-program product as recited in claim 10, wherein determining the quality metric comprises:
transmitting one or more data packets to one of the destination nodes;
receiving the data packets after the data packets have been looped back from the destination node; and
measuring the quality metric based on the looped back data packets.

17. A computer-program product as recited in claim 10, wherein determining the quality metric comprises receiving the quality metric from the destination node, the quality metric representing quality of packets communicated between the destination node and another node.

18. A computer-program product as recited in claim 17, wherein determining the quality metric comprises deriving the quality metric based on the pattern of receiving packets at the destination node.

19. A computer-program product as recited in claim 10 wherein the quality metric is selected from a group including packet loss, jitter, and latency.

20. A system for determining packet quality on an Internet protocol-based (IP-based) network, the system comprising:
a packet test device tracing multiple paths on the IP-based network to obtain node identifiers corresponding to nodes on each path, each path terminating at an associated destination node; and
an Internet quality monitor (IQM) associating a quality metric with each path, determining one or more links in each path, and associating each of the one or more links with one of the quality metrics.

21. A system as recited in claim 20, wherein the packet test device is embodied in one or more of a media gateway, a voice over Internet protocol (VOIP) terminal adapter, or a VOIP telephone.

22. A system as recited in claim 20, wherein the packet test device uses traditional means for performing an IP-based traceroute.

23. A system as recited in claim 20, wherein the packet test device performs a Session Initiation Protocol (SIP)—based traceroute function to obtain the node identifiers.

24. A system as recited in claim 20 wherein the IQM identifies an autonomous system including one or more nodes on a path and attributes one of the quality metrics to the autonomous system.

25. A system as recited in claim 20 wherein the IQM identifies a geographic region associated with one or more nodes on a path and attributes one of the quality metrics to the geographic region.

26. A system as recited in claim 20 wherein the IQM identifies an Internet Service Provider (ISP) associated with one or more nodes on a path and attributes one of the quality metrics to the ISP.

27. A system as recited in claim 20 wherein the IP-based network includes a voice over IP network.
